(19) United States
(12) Patent Application Publication
(10) Pub. No.: US 2025/0244198 A1
(43) Pub. Date: Jul. 31, 2025

(54) OPTICAL TEST STRUCTURE AND APPLICATION THEREOF

(71) Applicant: TAIWAN SEMICONDUCTOR MANUFACTURING COMPANY, LTD., Hsinchu (TW)

(72) Inventors: Tsun-Hsu CHEN, Hsinchu (TW); Yi-Chien WU, Hsinchu (TW); Wei Siang TAN, Hsinchu (TW); Cheng-Che CHUNG, Hsinchu (TW); Yu-Chia LIU, Hsinchu (TW); Kang-Che HUANG, Hsinchu (TW); Jung-Huei PENG, Hsinchu (TW); Chun-Wen CHENG, Hsinchu (TW)

(73) Assignee: TAIWAN SEMICONDUCTOR MANUFACTURING COMPANY, LTD., Hsinchu (TW)

(21) Appl. No.: 18/428,886

(22) Filed: Jan. 31, 2024

(51) Int. Cl. G01M 11/02

(52) U.S. Cl. CPC G01M 11/0207

(57) ABSTRACT

An optical test structure includes a substrate and at least one optical unit. The at least one optical unit is disposed on the substrate, and includes a first optical element, a second optical element, a third optical element, and a fourth optical element which are spaced apart from each other. The second optical element is disposed between the first optical element and the third optical element. The third optical element is disposed between the second optical element and the fourth optical element. A size of the third optical element is larger than a size of each of the first optical element, the second optical element, and the fourth optical element. The size of each of the second optical element and the fourth optical element is larger than the size of the first optical element.

### BACKGROUND

Meta-optics is an optical technique using meta-surfaces or meta-structures to manipulate characteristics of light (for example, phase, amplitude, or polarization of the light) when the light passes through the meta-surfaces or the meta-structures. A meta-optical device is generally composed of a planar light-transmissive substrate and millions of dielectric subwavelength nanostructures arranged in an array on the planar light-transmissive substrate. In recent years, meta-optical devices (for example, metalens-based devices) have been applied in various fields, such as holographic display, augmented and virtual reality, or optical sensors.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flow diagram illustrating a method for manufacturing an optical test structure in accordance with some embodiments.

FIGS. 2 to 3C are schematic views illustrating intermediate stages of the method as depicted in FIG. 1 in accordance with some embodiments.

FIGS. 4A to 5 are schematic views illustrating an inline optical measurement of an optical device using the optical test structure as depicted in FIG. 3A in accordance with some embodiments.

FIG. 6 is a simulation diagram illustrating a relationship between a normalized intensity of a light beam produced in the inline optical measurement as depicted in FIG. 4A or 5 and a critical dimension difference of an optical element of the optical test structure as depicted in FIG. 3A in accordance with some embodiments.

FIG. 7A is a schematic view illustrating a plurality of optical elements of an optical test structure in accordance with some embodiments.

FIG. 7B is a schematic view illustrating a cross section of one of the optical elements of the optical test structure as depicted in FIG. 7A in accordance with some embodiments.

FIG. 7C is a schematic view illustrating an optical element of an optical test structure in accordance with some embodiments.

FIG. 7D is a schematic view illustrating a cross section of the optical element of the optical test structure as depicted in FIG. 7C in accordance with some embodiments.

FIG. 8 is a simulation diagram illustrating a relationship between a critical dimension of the optical element of the optical test structure as depicted in FIG. 3A and different sidewall angles of a sidewall of the optical element in accordance with some embodiments.

FIG. 9 is a diagram illustrating a relationship between device performance of an optical device and optical readout of an optical test structure in accordance with some embodiments.

FIG. 10 is a diagram illustrating a relationship between device performance of an optical device and measurement readout of an inline inspection equipment using a common equipment.

FIGS. 11A and 11B are schematic views respectively illustrating measurement results of an optical structure of an optical device determined by the inline inspection equipment using the common equipment without a charging effect and with the charging effect.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “on,” “over,” “top,” “bottom,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. It should be noted that the element(s) or feature(s) are exaggeratedly shown in the figures for the purposed of convenient illustration and are not in scale.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some aspects ±10%, in some aspects ±5%, in some aspects ±2.5%, in some aspects ±1%, in some aspects ±0.5%, and in some aspects ±0.1% from the specified amount, as such variations are appropriate to perform the disclosed methods or employ the disclosed compositions.

In a process for manufacturing a meta-optical device with a meta-lens structure, an inline inspection process is usually performed to measure a structural property (e.g., a critical dimension) or an optical property (e.g., a refractive index) of the meta-lens structure. For example, an inline after-etching-inspection (AEI) process is performed to measure a critical dimension of a top portion of the meta-lens structure. Measurement accuracy of the critical dimension of the meta-lens structure is important because the critical dimension of the meta-lens structure may be correlated to device performance of the meta-optical device. Currently, after formation of a meta-lens structure of a meta-optical device, a common equipment (e.g., a scanning electron microscope (SEM)) used in the inline AEI process may not accurately measure the critical dimension of the meta-lens structure because the meta-lens structure is complicated and is formed with a plurality of pillars that are non-periodically arranged. In this case, the device performance of the meta-optical device may be difficult to be predicted, and thus production quality and yield thereof may be adversely affected. Therefore, there is a need to improve measurement accuracy of the inline AEI process.

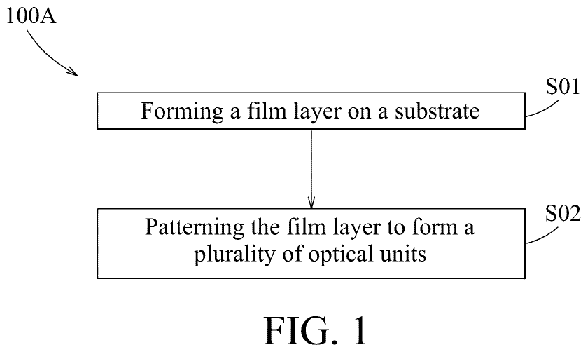

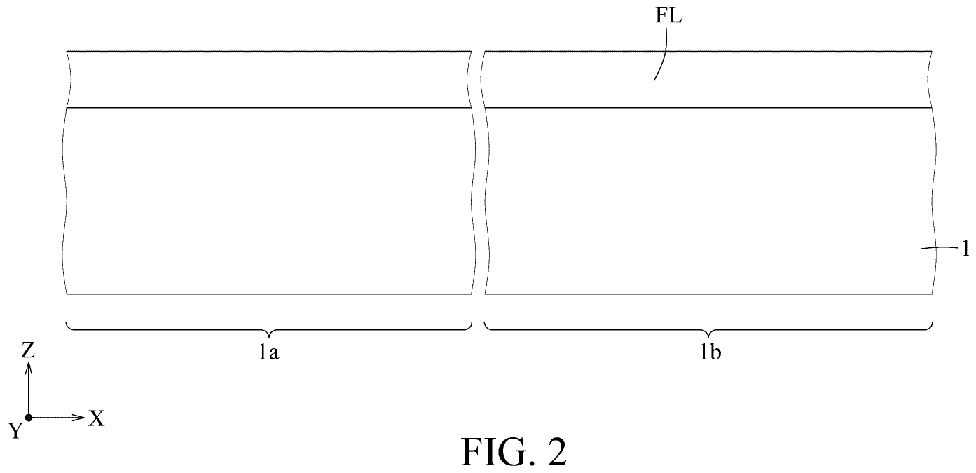

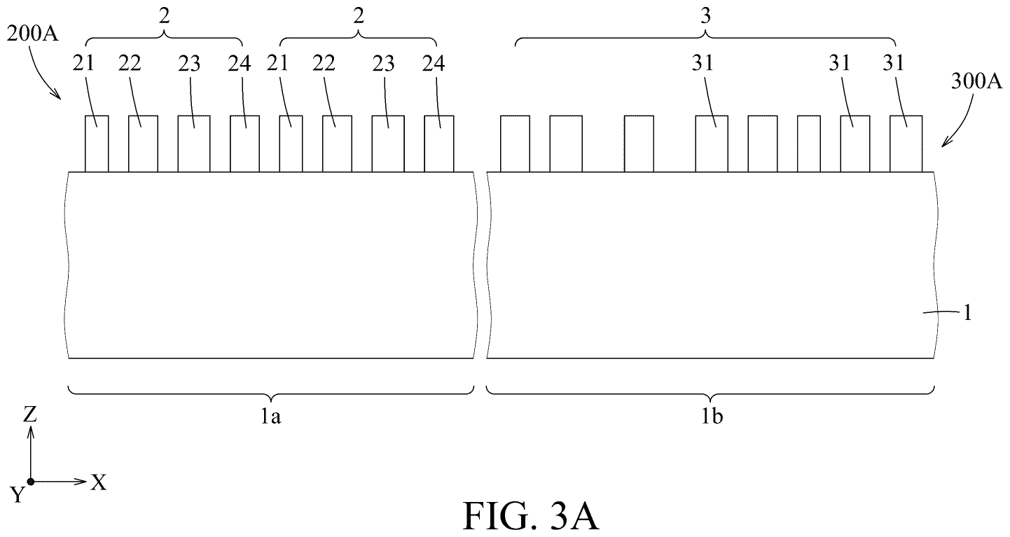

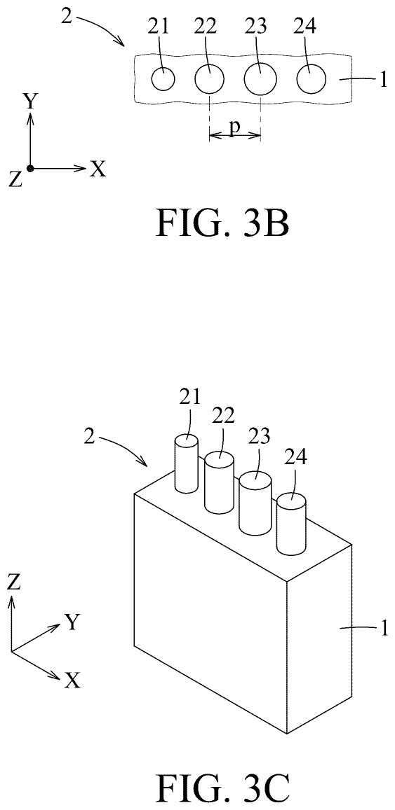

The present disclosure is directed to an optical test structure, a method for manufacturing the optical test structure, and an application of the optical test structure for an inline inspection process. FIG. 1 is a flow diagram illustrating a method 100A for manufacturing an optical test structure 200A shown in FIG. 3A in accordance with some embodiments. FIG. 2 illustrates a schematic view of an intermediate stage of the method 100A. Some portions may be omitted in FIG. 2 for the sake of brevity. Additional steps can be provided before, after or during the method 100A, and some of the steps described herein may be replaced by other steps or be eliminated.

Referring to FIG. 1 and the example illustrated in FIG. 2, the method 100A begins at step S01, where a film layer (FL) is formed on a substrate 1. The substrate 1 may be made of a light-transmissive material which is non-conductive. In some embodiments, the light-transmissive material may include, for example, but not limited to, glass, quartz, fused silica, an oxide-based material, or combinations thereof. Other suitable materials for forming the substrate 1 are within the contemplated scope of the present disclosure. In some embodiments, the substrate 1 may include a first region 1a and a second region 1b.

In some embodiments, the film layer (FL) may be made of a dielectric material, for example, but not limited to, silicon nitride, polysilicon, or a combination thereof. Other suitable materials for forming the film layer (FL) are within the contemplated scope of the present disclosure. The film layer (FL) may be formed on the substrate 1 by a suitable deposition process, for example, but not limited to, chemical vapor deposition (CVD), physical vapor deposition (PVD), or atomic layer deposition (ALD). Other suitable deposition processes for forming the film layer (FL) are within the contemplated scope of the present disclosure.

Referring to FIG. 1 and the example illustrated in FIGS. 3A to 3C, the method 100A then proceeds to step S02, where a plurality of optical units 2 are formed on the substrate 1 in a Z direction normal to the substrate 1. FIG. 3B is a schematic top view illustrating one of the optical units 2. FIG. 3C is a schematic perspective view of FIG. 3B. In some embodiments, the optical units 2 are formed in the first region 1a of the substrate 1.

In some embodiments, the film layer (FL) formed on the substrate 1 (see FIG. 2) is patterned by a suitable lithography process, so as to form the optical units 2. The lithography process may be a photolithography process or an electron beam lithography process. Other suitable processes for patterning the film layer (FL) are within the contemplated scope of the present disclosure. For example, the photolithography process (which includes an etching process) may include, for example, but not limited to, coating a photoresist (not shown) on the film layer (FL), soft-baking the photoresist, exposing the photoresist through a photomask (not shown), post-exposure baking the photoresist, and developing the photoresist, followed by hard-baking the photoresist, so as to form a patterned photoresist covering the film layer (FL). In the etching process, the film layer (FL) covered by the patterned photoresist is etched by a suitable etching process, for example, but not limited to, dry etching, wet etching, or a combination thereof, so as to obtain the optical units 2. Other suitable etching processes are within the contemplated scope of the present disclosure.

In some embodiments, each of the optical units 2 may include a first optical element 21, a second optical element 22, a third optical element 23, and a fourth optical element 24 which are spaced apart from one another in an X direction transverse to the Z direction. In some embodiments, the second optical element 22 is disposed between the first optical element 21 and the third optical element 23, and the third optical element 23 is disposed between the second optical element 22 and the fourth optical element 24. In some embodiments, each of the first optical element 21, the second optical element 22, the third optical element 23, and the fourth optical element 24 may be formed as a pillar-like structure. In this case, each of the first optical element 21, the second optical element 22, the third optical element 23, and the fourth optical element 24 may be formed as a nanopillar. Other suitable geometrical structures for the first optical element 21, the second optical element 22, the third optical element 23, and the fourth optical element 24 are within the contemplated scope of the present disclosure. In some embodiments, each of the first optical element 21, the second optical element 22, the third optical element 23, and the fourth optical element 24 may have a circular shape, a rectangular shape, or a square shape. Other suitable geometrical shapes for the first optical element 21, the second optical element 22, the third optical element 23, and the fourth optical element 24 are within the contemplated scope of the present disclosure.

As shown in FIGS. 3B and 3C, in some embodiments, a critical dimension (or a size) of the third optical element 23 is larger than that of each of the first optical element 21, the second optical element 22, and the fourth optical element 24, and the critical dimension of each of the second optical element 22 and the fourth optical element 24 is larger than that of the first optical element 21. In some embodiments, the critical dimension of the second optical element 22 may be the same as that of the fourth optical element 24.

In some embodiments, the optical units 2 are arranged in an array. In some embodiments, the first optical element 21 of one of the optical units 2 is proximate to the fourth optical element 24 of an adjacent one of the optical units 2 in the X direction. In some embodiments, in two of the optical units 2 adjacent to each other in a Y direction transverse to the X direction and Z direction, the first optical element 21, the second optical element 22, the third optical element 23, and the fourth optical element 24 of one of the two of the optical units 2 are respectively aligned with the first optical element 21, the second optical element 22, the third optical element 23, and the fourth optical element 24 of the other one of the two of the optical units 2 in the Y direction. It is noted that there is no limitation on the number of the optical units 2 as long as all of the optical units 2 can be covered by a spot sized projection on the optical test structure 200A by a light source used in an inline optical measurement (which will be described hereinafter).

After step S02, the optical test structure 200A is obtained. In some embodiments, after step S02, an optical structure 3 of an optical device 300A may be partially or completely formed in the second region 1b of the substrate 1 simultaneously. The substrate 1, the optical units 2, and the optical structure 3 collectively constitute an optical assembly. In some embodiments, the optical structure 3 of the optical device 300A may include a plurality of optical elements 31 which are spaced apart from one another in the X direction and the Y direction, and which are non-periodically arranged in the second region 1b of the substrate 1. In some embodiments, the optical structure 3 may be made of a material the same as that for forming the optical test structure 200A. In some embodiments, the optical structure 3 is made from the film layer (FL) (see FIG. 2) which is also used to form the optical test structure 200A. In some embodiments, each of the optical elements 31 may be formed with a pillar-like structure (e.g., the nanopillars). Other suitable geometrical structures for the optical elements 31 are within the contemplated scope of the present disclosure. In some embodiments, each of the optical elements 31 may have a circular shape, a rectangular shape, or a square shape. Other suitable geometrical shapes for the optical elements 31 are within the contemplated scope of the present disclosure. In some embodiments, the optical structure 3 of the optical device 300A may be referred to as a meta-lens structure. In some embodiments, the optical device 300A may be a meta-optical device.

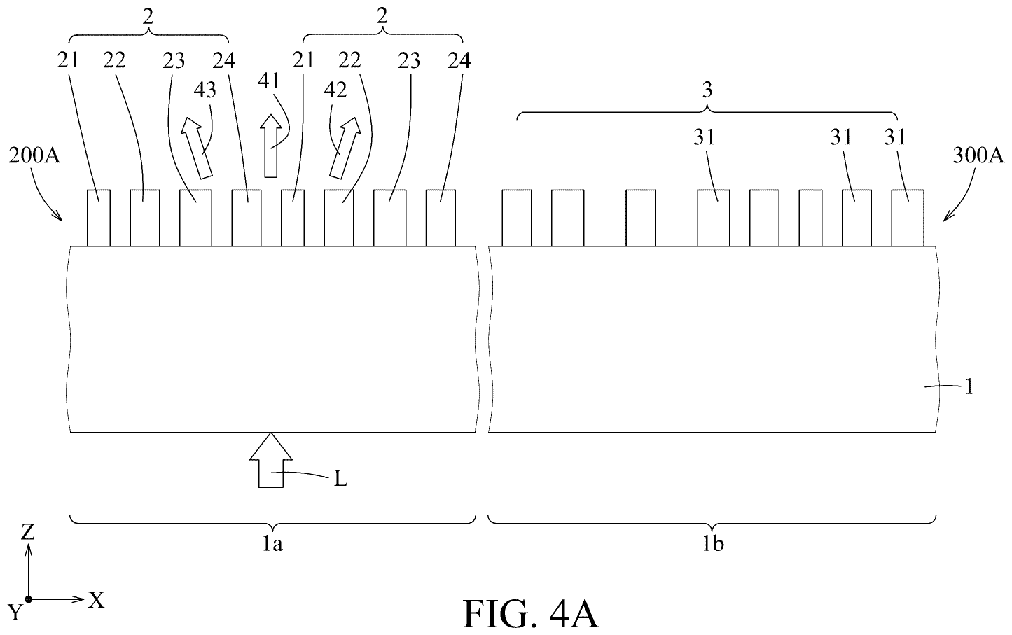

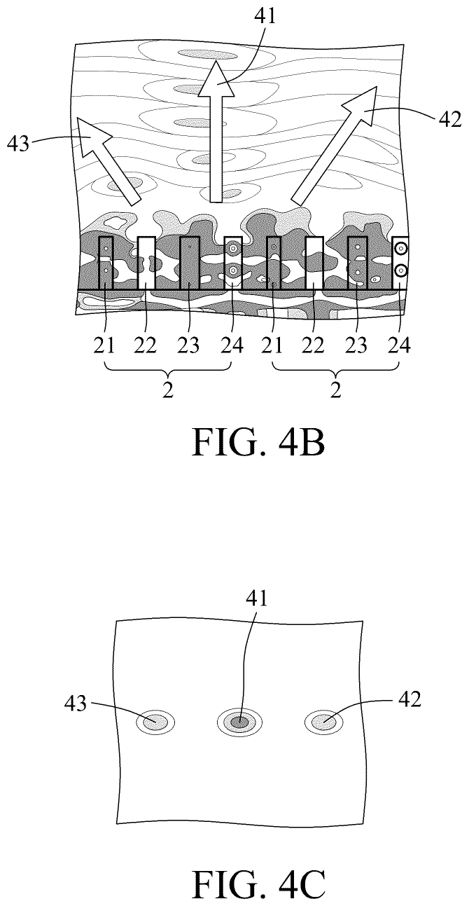

FIGS. 4A to 5 illustrate the inline optical measurement that is performed on the optical test structure 200A during the manufacturing process of the optical device 300A. In some embodiments, the inline optical measurement may be performed after the etching process (i.e., step S02). The optical measurement result may be correlated to device performance of the optical device 300A.

As shown in FIGS. 4A to 4C, in the inline optical measurement, light (L) emitted from the light source (not shown) is incident on a backside of the optical test structure 200A (i.e., a side of the optical test structure 200A distal from the optical units 2). FIGS. 4B and 4C illustrate a simulation model for simulating a travelling path of the light (L) passing through the optical test structure 200A during the inline optical measurement. FIG. 4C is a schematic top view of FIG. 4B. In some embodiments, the light (L) may have a wavelength ranging from about 760 nm to about 1 mm (e.g., a wavelength range of infrared radiation (IR)). In some embodiments, the light source may be a lamp, a light-emitting diode (LED), a micro LED, or a laser diode. Other suitable light sources are within the contemplated scope of the present disclosure. In some embodiments, after passing through the optical test structure 200A, the light (L) may be split into a first light beam 41, a second light beam 42, and a third light beam 43. It is noted that there is no particular limitation on the number of light beams formed after the light (L) passes through the optical test structure 200A. In some embodiments, the first light beam 41, the second light beam 42, and the third light beam 43 may respectively travel in a first travelling direction, a second travelling direction, and a third travelling direction, which are different from each other and which are away from the optical test structure 200A. In some embodiments, the first travelling direction is normal to the substrate 1, the second travelling direction and the first travelling direction may form an included angle that is greater than about 0 degrees and up to about 45 degrees, and the third travelling direction and the first travelling direction may form another included angle that is greater than about 0 degrees and up to about 45 degrees. In some embodiments, an intensity of each of the first light beam 41, the second light beam 42, and the third light beam 43 may be measured by, for example, but not limited to, an image sensor, a photometer, or a power meter. Other suitable equipment for measuring the intensity of the first light beam 41, the second light beam 42, and the third light beam 43 are within the contemplated scope of the present disclosure. As shown in FIG. 4C, in some embodiments, the intensity of the first light beam 41 is greater than that of each of the second light beam 42 and the third light beam 43.

As shown in FIG. 5, in some embodiments, in the inline optical measurement, the light (L) emitted from the light source (not shown) is incident on a topside of the optical test structure 200A (i.e., a side proximate to the optical units 2), and is split into the first light beam 41, the second light beam 42 and the third light beam 43 after passing through the optical test structure 200A.

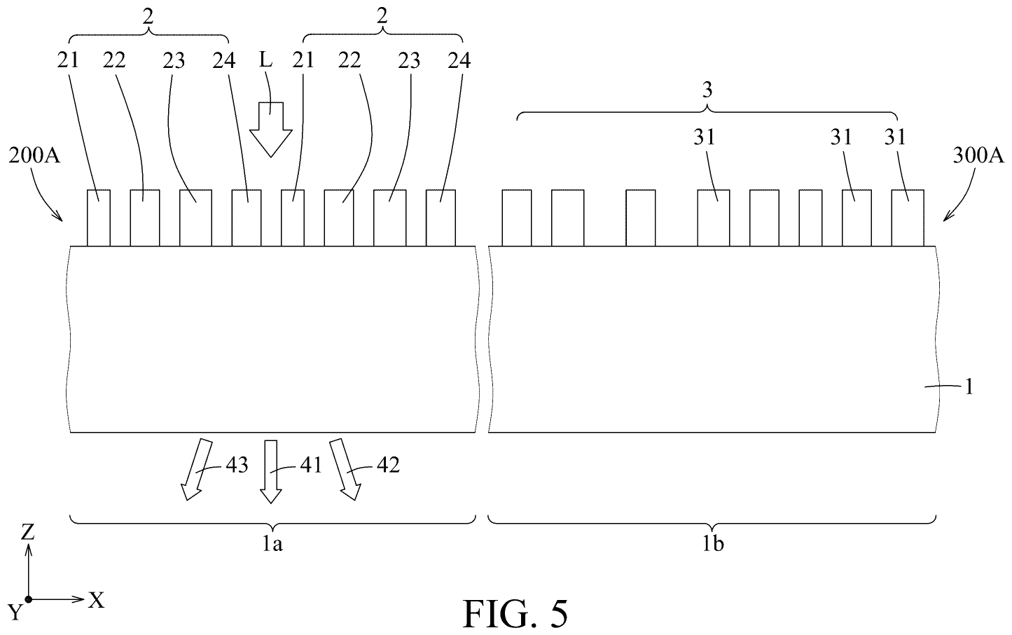

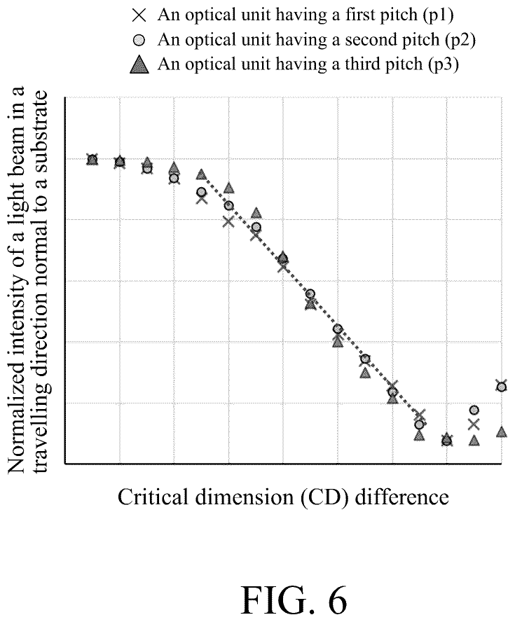

FIG. 6 illustrates a simulation result of a relationship between a normalized intensity of the first light beam 41 shown in FIG. 4A, 4B, 4C, or 5 (i.e., the light beam having the first travelling direction normal to the substrate 1) and a difference defined between a predetermined critical dimension of an optical element (e.g., the first optical element 21, the second optical element 22, the third optical element 23, or the fourth optical element 24) of the optical unit 2 and a measured critical dimension thereof. In this simulation, the critical dimension of the optical element of each of three different optical units 2 having different pitches (p) (which will be described hereinafter) is measured. The simulation result shows that the normalized intensity of the first light beam 41 within a certain range of intensity is proportional to the difference defined between the predetermined critical dimension of the optical element of the optical unit 2 and the measured critical dimension thereof within a certain range of difference. The difference defined between the predetermined critical dimension of the optical element of the optical unit 2 and the measured critical dimension thereof is referred to as a critical dimension (CD) difference herein. In this case, when a normalized intensity of the first light beam 41 within the certain range of intensity is measured from the optical unit 2 of the optical test structure 200A, the CD difference of the optical element of the optical unit 2 can be obtained from the simulation result shown in FIG. 6. The CD difference thus obtained can be in turn used to predict structural and optical characteristics (for example, but not limited to, a top critical dimension, a thickness, a sidewall angle, or a refractive index) of the optical structure 3 of the optical device 300A in an inline optical measurement (which will be described hereinafter), and these characteristics are related to device performance (e.g., light intensity or image quality) of the optical device 300A. In some embodiments, the certain range of intensity of the normalized intensity of the first light beam 41 ranges from about 0.1 to about 0.9. In some embodiments, the certain range of difference of the CD difference of the optical element of the optical unit 2 of the optical test structure 200A ranges from about 5 nm to about 45 nm.

Referring to FIG. 3B, in some embodiments, the critical dimension of the first optical element 21 may range from about 125 nm to about 185 nm; the critical dimension of the second optical element 22 may range from about 145 nm to about 205 nm; the critical dimension of the third optical element 23 may range from about 165 nm to about 225 nm; and the critical dimension of the fourth optical element 24 may range from about 145 nm to about 205 nm. In some embodiments, a difference between the critical dimensions of two adjacent ones of the first optical element 21, the second optical element 22, the third optical element 23, and the fourth optical element 24 is the same across all of the first optical element 21, the second optical element 22, the third optical element 23 and the fourth optical element 24. In this case, such difference may range from about 10 nm to about 20 nm. When the critical dimension of each of the first optical element 21, the second optical element 22, the third optical element 23 and the fourth optical element 24 is smaller than a lower limit of the range of the critical dimension as described above, the proportional relationship between the normalized intensity of the first light beam 41 and the CD difference of the optical element of the optical unit 2 of the optical test structure 200A shown in FIG. 6 cannot be obtained, and thus the structural and optical characteristics of the optical structure 3 and the device performance of the optical device 300A cannot be predicted in the inline optical measurement. When the critical dimension of each of the first optical element 21, the second optical element 22, the third optical element 23 and the fourth optical element 24 is greater than an upper limit of the range of the critical dimension as described above, the proportional relationship between the normalized intensity of the first light beam 41 and the CD difference of the optical element of the optical unit 2 of the optical test structure 200A shown in FIG. 6 also cannot be obtained, and thus the structural and optical characteristics of the optical structure 3 and the device performance of the optical device 300A cannot be predicted in the inline optical measurement. It is noted that the critical dimension of each of the first optical element 21, the second optical element 22, the third optical element 23 and the fourth optical element 24 of the optical unit 2 of the optical test structure 200A may refer to the critical dimension of a top portion of each of the first optical element 21, the second optical element 22, the third optical element 23 and the fourth optical element 24.

In some embodiments, the pitch (p) shown in FIG. 3B is defined as a distance between a geometrical center of one of the first optical element 21, the second optical element 22, the third optical element 23 and the fourth optical element 24 of the optical unit 2 of the optical test structure 200A, and a geometrical center of an adjacent one of the first optical element 21, the second optical element 22, the third optical element 23 and the fourth optical element 24 of the optical unit 2 of the optical test structure 200A. In some embodiments, the pitch (p) may range from about 300 nm to about 500 nm. When the pitch (p) is less than about 300 nm, a measurement range of the critical dimension of the optical element of the optical units 2 of the optical test structure 200A may be reduced in the inline optical measurement, and difficulty in forming the optical units 2 of the optical test structure 200A may be increased. When the pitch (p) is greater than about 500 nm, the proportional relationship between the normalized intensity of the first light beam 41 and the CD difference of the optical element of the optical unit 2 shown in FIG. 6 cannot be obtained, and thus the structural and optical characteristics of the optical structure 3 and the device performance of the optical device 300A cannot be predicted in the inline optical measurement. It is noted that the pitch (p) may be adjusted depending on a structural design of the optical device 300A to be manufactured.

In some embodiments, the CD difference (i.e., the difference defined between the predetermined critical dimension of the optical element of the optical unit 2 and the measured critical dimension thereof, as shown in FIG. 6) may reflect a change in the geometrical structure thereof, which may be caused by variation of manufacturing process conditions.

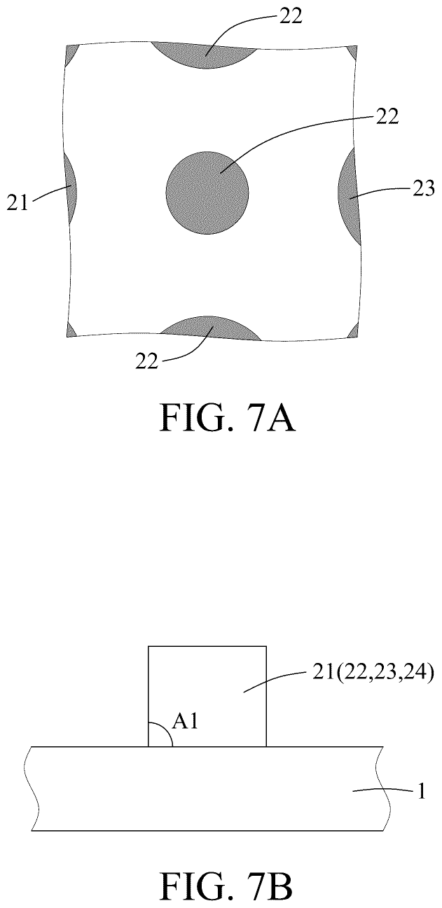

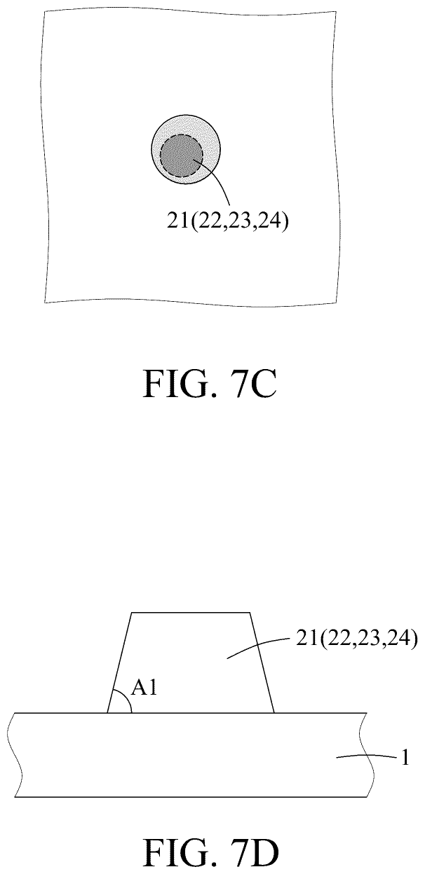

Referring to FIGS. 7A to 7D, in some embodiments, each of the first optical element 21, the second optical element 22, the third optical element 23, and the fourth optical element 24 of the optical units 2 of the optical test structure 200A is formed as a pillar-like structure (e.g., a nano-pillar structure), and may have a vertical sidewall (see FIGS. 7A and 7B) or a slanted sidewall (see. FIGS. 7C and 7D) with respect to a top surface of the substrate 1. FIG. 7B shows a cross section of one of the first optical element 21, the second optical element 22, the third optical element 23, and the fourth optical element 24 shown in FIG. 7A. FIG. 7C shows one of the first optical element 21, the second optical element 22, the third optical element 23, and the fourth optical element 24. FIG. 7D shows a cross section of the one of the first optical element 21, the second optical element 22, the third optical element 23, and the fourth optical element 24 shown in FIG. 7C.

Formation of the slanted sidewall of the one of the first optical element 21, the second optical element 22, the third optical element 23, and the fourth optical element 24 may be caused by the film layer (FL) being overetched during the etching process as described above with reference to FIG. 2 or other processing procedures. As shown in FIG. 7C, the sidewall of the one of the first optical element 21, the second optical element 22, the third optical element 23 and the fourth optical element 24 tapers in a direction from a bottom surface thereof to a top surface thereof. As shown in FIG. 7D, the one of the first optical element 21, the second optical element 22, the third optical element 23 and the fourth optical element 24 has a cross section that has a trapezoid shape, and a sidewall angle (A1) defined between the sidewall and the bottom surface of the one of the first optical element 21, the second optical element 22, the third optical element 23 and the fourth optical element 24 may be at least about 88 degrees and less than about 90 degrees. In some embodiments, the sidewall of one of the first optical element 21, the second optical element 22, the third optical element 23 and the fourth optical element 24 may taper in a direction from a top surface thereof to a bottom surface thereof. In this case, the one of the first optical element 21, the second optical element 22, the third optical element 23 and the fourth optical element 24 has a cross section that has an inverted trapezoid shape, and the sidewall angle (A1) may be greater than about 90 degrees and up to about 90.5 degrees.

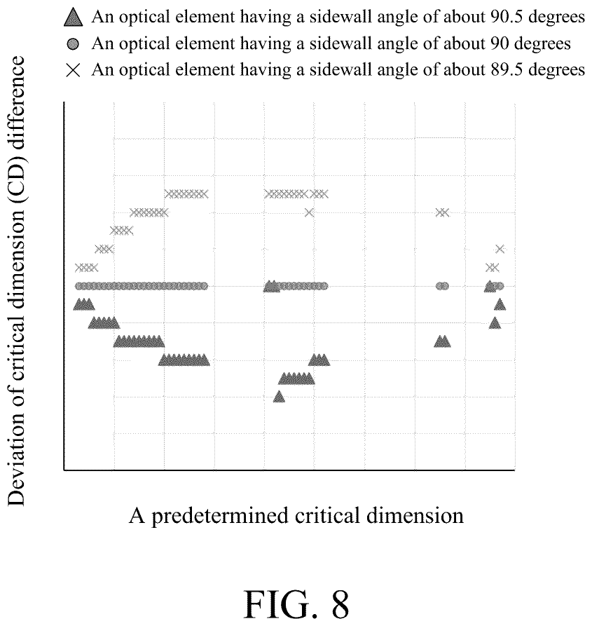

FIG. 8 illustrates simulation results of a relationship between a deviation of the CD difference and the predetermined critical dimension among an optical element of the optical unit 2 having a sidewall angle of about 89.5 degrees, an optical element of the optical unit 2 having a sidewall angle of about 90 degrees, and an optical element of the optical unit 2 having a sidewall angle of about 90.5 degrees. The simulation results show that the CD difference obtained from the optical element of the optical unit 2 having a sidewall angle of about 89.5 degrees or the optical element of the optical unit 2 having a sidewall angle of about 90.5 degrees may deviate from the CD difference obtained from the optical element of the optical unit 2 having a sidewall angle of about 90 degrees by a deviation value. In some embodiments, the deviation value may range from about 0 nm to about 5 nm. In some embodiments, the deviation may be caused by variation of the manufacturing process conditions, and may be reflected by the intensity of the first light beam 41 in the inline optical measurement.

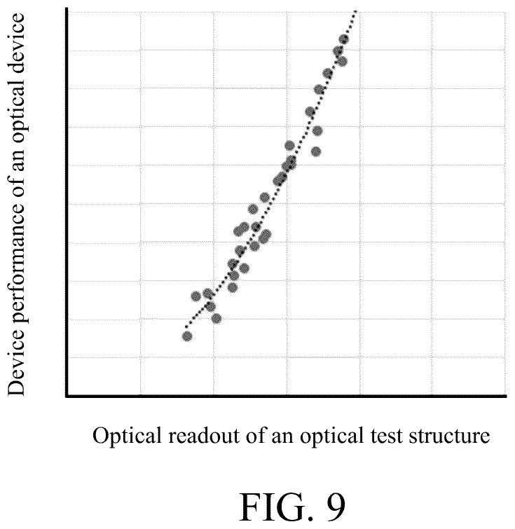

FIG. 9 illustrates a relationship between the device performance of the optical device 300A and an optical measurement readout (e.g., the normalized intensity of the first light beam 41) of the optical test structure 200A subjected to an inline optical measurement. As shown in FIG. 9, a high correlation exists between the device performance of the optical device 300A and the measurement readout of the optical test structure 200A. Referring to FIG. 4A or 5, when the optical test structure 200A and the optical structure 3 of the optical device 300A are formed on the substrate 1, the normalized intensity of the first light beam 41 can be measured in the inline optical measurement, and is used for predicting the device performance of the optical device 300A based on the correlation as shown in FIG. 9. Therefore, device performance of an optical device to be manufactured may be precisely predicted in the inline optical measurement, which is conducive to shortening an inspection time, improving productivity of the optical device, and efficiently reducing production cost of the optical device.

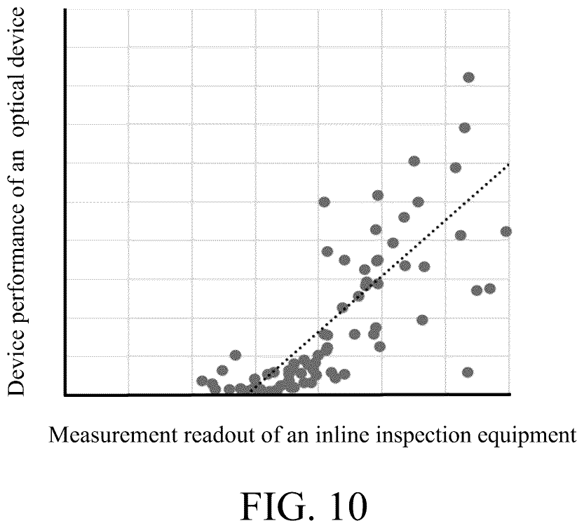

FIG. 10 illustrates a relationship between the device performance of an optical device and a measurement readout (e.g., a critical dimension (CD)) of a common inline inspection equipment (e.g., an SEM for an AEI CD measurement). As shown in FIG. 10, a poor correlation exists between the device performance of the optical device and the measurement readout of the SEM. In other words, the measurement readout of the SEM may not accurately reflect an effect of variation of the manufacturing process conditions on the device performance of the optical device. A measurement accuracy of the SEM may be adversely affected due to a charging effect that occurs during the inline AEI process (which will be described hereinafter).

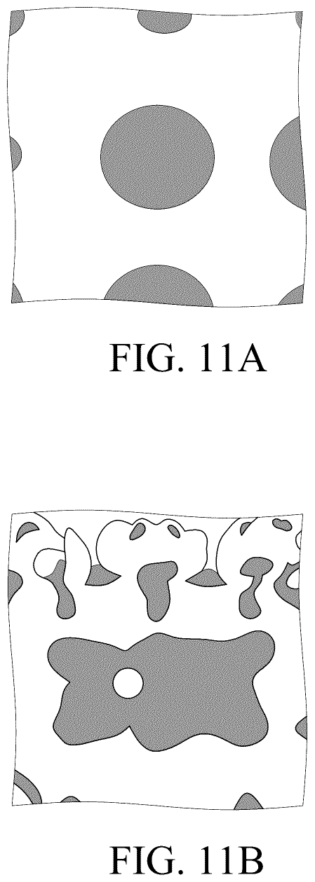

FIGS. 11A and 11B respectively illustrate surface morphologies of an optical structure of an optical device measured by the SEM in the inline AEI process. The optical device may be similar to the optical device 300A (e.g., a meta-optical device), and the structure of the optical device may be similar to the optical structure 3 (e.g., a meta-lens structure) of the optical device 300A and may include a plurality of optical elements (e.g., nanopillars). As shown in FIG. 11A, the surface morphology of the optical structure of the optical device can be clearly observed without the charging effect during the inline AEI process. As shown in FIG. 11B, the surface morphology of the optical structure of the optical device can not be clearly observed due to the charging effect, which adversely affects image quality and the measurement accuracy of the SEM.

Compared with the common inline inspection equipment (e.g., the SEM for the AEI CD measurement), the measurement accuracy of the inline optical measurement using the optical test structure 200A may not be affected by the charging effect or other measurement factors. Therefore, the inline optical measurement using the optical test structure 200A may more precisely reflect an effect of variation of the manufacturing process conditions on the device performance of the optical device 300A. As such, the device performance of the optical device 300A can be predicted in the inline optical measurement.

In a process for manufacturing an optical device (for example, a meta-optical device), by having an optical test structure of this disclosure and by performing an inline optical measurement using the optical test structure, an optical measurement readout (e.g., a normalized intensity of a light beam from a substrate, on which the optical test structure is formed, in a travelling path normal to the substrate) may reflect an effect of variation of manufacturing process conditions on device performance of the optical device, such that the device performance of the optical device may be precisely predicted, which is conducive to shortening an inspection time, improving productivity of the optical device, and efficiently reducing production cost of the optical device.

In accordance with some embodiments of the present disclosure, an optical test structure includes a substrate and at least one optical unit. The at least one optical unit is disposed on the substrate, and includes a first optical element, a second optical element, a third optical element, and a fourth optical element which are spaced apart from each other. The second optical element is disposed between the first optical element and the third optical element. The third optical element is disposed between the second optical element and the fourth optical element. A size of the third optical element is larger than a size of each of the first optical element, the second optical element, and the fourth optical element. The size of each of the second optical element and the fourth optical element is larger than the size of the first optical element.

In accordance with some embodiments of the present disclosure, the size of the second optical element is the same as the size of the fourth optical element.

In accordance with some embodiments of the present disclosure, the size of the first optical element ranges from about 125 nm to about 185 nm.

In accordance with some embodiments of the present disclosure, the size of the second optical element ranges from about 145 nm to about 205 nm.

In accordance with some embodiments of the present disclosure, the size of the third optical element ranges from about 165 nm to about 225 nm.

In accordance with some embodiments of the present disclosure, the size of the fourth optical element ranges from about 145 nm to about 205 nm.

In accordance with some embodiments of the present disclosure, a difference between the sizes of two adjacent ones of the first optical element, the second optical element, the third optical element, and the fourth optical element is the same across all of the first optical element, the second optical element, the third optical element, and the fourth optical element.

In accordance with some embodiments of the present disclosure, the difference ranges from about 10 nm to about 20 nm.

In accordance with some embodiments of the present disclosure, a distance between a geometrical center of one of the first optical element, the second optical element, the third optical element and the fourth optical element, and a geometrical center of an adjacent one of the first optical element, the second optical element, the third optical element and the fourth optical element ranges from about 300 nm to about 500 nm.

In accordance with some embodiments of the present disclosure, an optical assembly includes a substrate, an optical structure, and an optical test structure. The substrate has a surface. The optical structure is disposed on the surface of the substrate. The optical test structure is disposed on the surface of the substrate, is spaced apart from the optical structure, and includes at least one optical unit that contains a first optical element, a second optical element, a third optical element, and a fourth optical element spaced apart from each other in an X direction parallel to the surface of the substrate. The second optical element is disposed between the first optical element and the third optical element. The third optical element is disposed between the second optical element and the fourth optical element. A size of the third optical element is larger than a size of each of the first optical element, the second optical element, and the fourth optical element. The size of each of the second optical element and the fourth optical element is larger than the size of the first optical element.

In accordance with some embodiments of the present disclosure, the at least one optical unit includes a plurality of the optical units arranged in an array.

In accordance with some embodiments of the present disclosure, in two of the optical units adjacent to each other in a Y direction parallel to the surface of the substrate and transverse to the X direction, the first optical element, the second optical element, the third optical element, and the fourth optical element of one of the two of the optical units are respectively aligned with the first optical element, the second optical element, the third optical element, and the fourth optical element of the other one of the two of the optical units.

In accordance with some embodiments of the present disclosure, each of the first optical element, the second optical element, the third optical element, and the fourth optical element has a slanted sidewall with respect to the surface of the substrate.

In accordance with some embodiments of the present disclosure, the slanted sidewall of each of the first optical element, the second optical element, the third optical element and the fourth optical element tapers in a direction from a bottom surface of the each of the first optical element, the second optical element, the third optical element and the fourth optical element to a top surface of the each of the first optical element, the second optical element, the third optical element and the fourth optical element, and a sidewall angle defined between the slanted sidewall of the each of the first optical element, the second optical element, the third optical element and the fourth optical element and the bottom surface of the each of the first optical element, the second optical element, the third optical element and the fourth optical element is at least about 88 degrees and less than about 90 degrees.

In accordance with some embodiments of the present disclosure, each of the first optical element, the second optical element, the third optical element, and the fourth optical element has a vertical sidewall with respect to the surface of the substrate.

In accordance with some embodiments of the present disclosure, an optical test method for predicting device performance of an optical device includes: forming an optical test structure and an optical structure of the optical device on a substrate, the optical test structure and the optical structure being spaced apart from each other, the optical test structure including at least one optical unit that includes at least one optical element; emitting light through the optical test structure to generate a plurality of light beams, which travel away from the optical test structure in different travelling directions; receiving, by an optical sensing element, one of the light beams which travels in a travelling direction normal to the substrate, so as to measure an intensity of the one of the light beams; and detecting a variation in a size of the at least one optical element according to the intensity, so as to predict the device performance of the optical device.

In accordance with some embodiments of the present disclosure, formation of the optical structure and the optical test structure includes: forming a film layer on the substrate; and patterning the film layer to form the film layer into the optical structure and the optical test structure, the optical test structure including the at least one optical unit that contains a first optical element, a second optical element, a third optical element and a fourth optical element, the second optical element being disposed between the first optical element and the third optical element, the third optical element being disposed between the second optical element and the fourth optical element, a size of the third optical element being larger than a size of each of the first optical element, the second optical element, and the fourth optical element, the size of each of the second optical element and the fourth optical element being larger than the size of the first optical element.

In accordance with some embodiments of the present disclosure, the light is emitted from a light source with a spot sized projection which projects on the optical test structure so as to cover the at least one optical unit.

In accordance with some embodiments of the present disclosure, the intensity of the one of the light beams is higher than an intensity of each of the other ones of the light beams.

In accordance with some embodiments of the present disclosure, the other ones of the light beams travel in different travelling directions, each of which forms an included angle with the travelling direction of the one of the light beams, the included angle being greater than about 0 degrees and up to about 45 degrees.

The foregoing outlines features of several embodiments so that those skilled in the art may better understand the aspects of the present disclosure. Those skilled in the art should appreciate that they may readily use the present disclosure as a basis for designing or modifying other processes or structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical test structure, comprising:
a substrate; and
at least one optical unit disposed on the substrate, and including a first optical element, a second optical element, a third optical element, and a fourth optical element spaced apart from each other, the second optical element being disposed between the first optical element and the third optical element, the third optical element being disposed between the second optical element and the fourth optical element, a size of the third optical element being larger than a size of each of the first optical element, the second optical element, and the fourth optical element, the size of each of the second optical element and the fourth optical element being larger than the size of the first optical element.

2. The optical test structure as claimed in claim 1, wherein the size of the second optical element is the same as the size of the fourth optical element.

3. The optical test structure as claimed in claim 1, wherein the size of the first optical element ranges from 125 nm to 185 nm.

4. The optical test structure as claimed in claim 1, wherein the size of the second optical element ranges from 145 nm to 205 nm.

5. The optical test structure as claimed in claim 1, wherein the size of the third optical element ranges from 165 nm to 225 nm.

6. The optical test structure as claimed in claim 1, wherein the size of the fourth optical element ranges from 145 nm to 205 nm.

7. The optical test structure as claimed in claim 1, wherein a difference between the sizes of two adjacent ones of the first optical element, the second optical element, the third optical element, and the fourth optical element is the same across all of the first optical element, the second optical element, the third optical element, and the fourth optical element.

8. The optical test structure as claimed in claim 7, wherein the difference ranges from 10 nm to 20 nm.

9. The optical test structure as claimed in claim 1, wherein a distance between a geometrical center of one of the first optical element, the second optical element, the third optical element and the fourth optical element, and a geometrical center of an adjacent one of the first optical element, the second optical element, the third optical element and the fourth optical element ranges from 300 nm to 500 nm.

10. An optical assembly, comprising:
a substrate having a surface;
an optical structure disposed on the surface of the substrate; and
an optical test structure disposed on the surface of the substrate, spaced apart from the optical structure, and including at least one optical unit that contains a first optical element, a second optical element, a third optical element, and a fourth optical element spaced apart from each other in an X direction parallel to the surface of the substrate, the second optical element being disposed between the first optical element and the third optical element, the third optical element being disposed between the second optical element and the fourth optical element, a size of the third optical element being larger than a size of each of the first optical element, the second optical element, and the fourth optical element, the size of each of the second optical element and the fourth optical element being larger than the size of the first optical element.

11. The optical assembly as claimed in claim 10, wherein the at least one optical unit includes a plurality of the optical units arranged in an array.

12. The optical assembly as claimed in claim 11, wherein in two of the optical units adjacent to each other in a Y direction parallel to the surface of the substrate and transverse to the X direction, the first optical element, the second optical element, the third optical element, and the fourth optical element of one of the two of the optical units are respectively aligned with the first optical element, the second optical element, the third optical element, and the fourth optical element of the other one of the two of the optical units.

13. The optical assembly as claimed in claim 10, wherein each of the first optical element, the second optical element, the third optical element, and the fourth optical element has a slanted sidewall with respect to the surface of the substrate.

14. The optical assembly as claimed in claim 13, wherein the slanted sidewall of each of the first optical element, the second optical element, the third optical element and the fourth optical element tapers in a direction from a bottom surface of the each of the first optical element, the second optical element, the third optical element and the fourth optical element to a top surface of the each of the first optical element, the second optical element, the third optical element and the fourth optical element, and a sidewall angle defined between the slanted sidewall of the each of the first optical element, the second optical element, the third optical element and the fourth optical element and the bottom surface of the each of the first optical element, the second optical element, the third optical element and the fourth optical element is at least 88 degrees and less than 90 degrees.

15. The optical assembly as claimed in claim 10, wherein each of the first optical element, the second optical element, the third optical element, and the fourth optical element has a vertical sidewall with respect to the surface of the substrate.

16. An optical test method for predicting device performance of an optical device, comprising:
forming an optical test structure and an optical structure of the optical device on a substrate, the optical test structure and the optical structure being spaced apart from each other, the optical test structure including at least one optical unit that includes at least one optical element;
emitting light through the optical test structure to generate a plurality of light beams, which travel away from the optical test structure in different travelling directions;
receiving, by an optical sensing element, one of the light beams which travels in a travelling direction normal to the substrate, so as to measure an intensity of the one of the light beams; and
detecting a variation in a size of the at least one optical element according to the intensity, so as to predict the device performance of the optical device.

17. The optical test method as claimed in claim 16, wherein formation of the optical structure and the optical test structure includes:
forming a film layer on the substrate; and
patterning the film layer to form the film layer into the optical structure and the optical test structure, the optical test structure including the at least one optical unit that contains a first optical element, a second optical element, a third optical element and a fourth optical element, the second optical element being disposed between the first optical element and the third optical element, the third optical element being disposed between the second optical element and the fourth optical element, a size of the third optical element being larger than a size of each of the first optical element, the second optical element, and the fourth optical element, the size of each of the second optical element and the fourth optical element being larger than the size of the first optical element.

18. The optical test method as claimed in claim 17, wherein the light is emitted from a light source with a spot sized projection which projects on the optical test structure so as to cover the at least one optical unit.

19. The optical test method as claimed in claim 16, wherein the intensity of the one of the light beams is higher than an intensity of each of the other ones of the light beams.

20. The optical test method as claimed in claim 19, wherein the other ones of the light beams travel in different travelling directions, each of which forms an included angle with the travelling direction of the one of the light beams, the included angle is greater than 0 degrees and up to 45 degrees.
